(19) United States
(12) Patent Application Publication
(10) Pub. No.: US 2019/0229887 A1
(43) Pub. Date: Jul. 25, 2019

(54) SECURE DATA PROCESSING

(71) Applicant: NOKIA TECHNOLOGIES OY, Espoo (FI)

(72) Inventors: Wenxiu DING, Shaanxi (CN); Zheng YAN, Shaanxi (CN)

(21) Appl. No.: 16/314,196

(22) PCT Filed: Jun. 30, 2016
(86) PCT No.: PCT/CN2016/087876

§ 371 Date: Dec. 28, 2018

(51) Int. Cl. H04L 9/00; H04L 9/14; H04L 9/08

(52) U.S. Cl. CPC H04L 9/008; H04L 9/0816; H04L 9/14

(57) ABSTRACT

According to an example aspect of the present invention, there is provided an apparatus comprising at least one processing core, at least one memory including computer program code, the at least one memory and the computer program code being configured to, with the at least one processing core, cause the apparatus at least to receive, from a data provider, a first ciphertext, perform a mathematical manipulation of the first ciphertext, the mathematical manipulation modifying plaintext of the first ciphertext without decrypting the first ciphertext, the mathematical manipulation being identified by a computation identifier, obtain a second ciphertext from the first ciphertext by performing a cryptographic re-encryption operation, and provide the second ciphertext to a first computation party.

### FIELD

The present invention relates to processing information in encrypted form, for example in a cloud service provision environment.

### BACKGROUND

Cloud computing services provide off-site opportunities for individuals and corporations. For example, cloud storage service enables off-site storage of data sets in a flexible manner in a data centre, reducing the need for users of the cloud service to obtain their own storage hardware, for example for archiving purposes.

A further example of a cloud service is a cloud processing service, wherein a user is given access to processor resources at a computer or computing grid. This may be useful, for example where a user needs access to high-capacity computing intermittently, and obtaining actual high-capacity computing hardware would be wasteful as the hardware would mostly be unused, since the need is only intermittent.

Consumers may use cloud services to back up their data, for example during operating system updates of their devices, such as computers, smartphones and laptops. Some smart devices are configured to automatically upload images captured by users to a cloud storage service.

While useful, cloud services present high risk to users. Personal information may accidentally, or purposefully, be stored on a cloud storage service. Such personal information may become vulnerable to theft, unauthorised modification or eavesdropping either during transit to or from the cloud storage service, or while in the cloud storage service. The cloud service provider may be untrusted or only partially trusted. Furthermore, the cloud service may be distributed between several data centres, and customer data may be communicated between such data centres to balance load between the centres. Such communication presents additional risk of eavesdropping.

As it relates to cloud processing services, risks are also present. Where a user seeks to analyse medical patient data, for example, not only the data itself but also its processing is highly confidential by its intrinsic nature. Similar considerations apply to other confidential data that may be processed, such as corporate, personal or military data. For example, analysing stealth-defeating radar may comprise complex processing of plural radar signals and their combinations. Clearly, such signal processing is secret due to its nature.

### SUMMARY OF THE INVENTION

The invention is defined by the features of the independent claims. Some specific embodiments are defined in the dependent claims.

According to a first aspect of the present invention, there is provided an apparatus comprising at least one processing core, at least one memory including computer program code, the at least one memory and the computer program code being configured to, with the at least one processing core, cause the apparatus at least to receive, from a data provider, a first ciphertext, perform a mathematical manipulation of the first ciphertext, the mathematical manipulation modifying plaintext of the first ciphertext without decrypting the first ciphertext, the mathematical manipulation being identified by a computation identifier, obtain a second ciphertext from the first ciphertext by performing a cryptographic re-encryption operation, and provide the second ciphertext to a first computation party.

Various embodiments of the first aspect may comprise at least one feature from the following bulleted list:
the apparatus is configured to obtain the computation identifier from the first computation party
the apparatus is further configured to participate in negotiating a shared secret with the first computation party
the cryptographic re-encryption operation is performed in dependence of the computation identifier
the second ciphertext is not decryptable solely by a secret key of the first computation party
the apparatus is further configured to obtain a key pair comprising a public key of the apparatus and a secret key of the apparatus
the computation identifier identifies at least one of the following processes: addition, subtraction, multiplication, sign acquisition, comparison, equivalence test and variance
the apparatus is further configured to obtain a third ciphertext from the first ciphertext, to provide the third ciphertext to a second computation party, and to obtain a fourth ciphertext from responses received in the apparatus from the first computation party and the second computation party, and to obtain an encrypted result of a computation process identified by the computation identifier.

According to a second aspect of the present invention, there is provided an apparatus comprising at least one processing core, at least one memory including computer program code, the at least one memory and the computer program code being configured to, with the at least one processing core, cause the apparatus at least to determine, based on a message from a data requester, a computation identifier, transmit a request to a data service provider, the request comprising the computation identifier, receive, from the data service provider, a first ciphertext, obtain a second ciphertext from the first ciphertext by performing a cryptographic re-encryption operation, and provide the second ciphertext to the data requester as a response to the message.

Various embodiments of the second aspect may comprise at least one feature from the following bulleted list:
the apparatus is further configured to check an access policy before providing the request to the data service provider
the apparatus is further configured to participate in negotiating a shared secret with the data service provider
the negotiating comprises a Diffie-Hellman negotiation
the apparatus is configured to perform the cryptographic re-encryption operation in dependence of the computation identifier
the computation identifier identifies one of the following computation processes: addition, subtraction, multiplication, sign acquisition, comparison, equivalence test and variance.

According to a third aspect of the present invention, there is provided a method comprising receiving, from a data provider, a first ciphertext, performing a mathematical manipulation of the first ciphertext, the mathematical manipulation modifying plaintext of the first ciphertext without decrypting the first ciphertext, the mathematical manipulation being identified by a computation identifier, obtaining a second ciphertext from the first ciphertext by performing a cryptographic re-encryption operation, and providing the second ciphertext to a first computation party.

Various embodiments of the third aspect may comprise at least one feature corresponding to a feature from the preceding bulleted list laid out in connection with the first aspect.

According to a fourth aspect of the present invention, there is provided a method comprising determining, based on a message from a data requester, a computation identifier, transmitting a request to a data service provider, the request comprising the computation identifier, receiving, from the data service provider, a first ciphertext, obtaining a second ciphertext from the first ciphertext by performing a cryptographic re-encryption operation, and providing the second ciphertext to the data requester as a response to the message.

Various embodiments of the fourth aspect may comprise at least one feature corresponding to a feature from the preceding bulleted list laid out in connection with the second aspect.

According to a fifth aspect of the present invention, there is provided a system comprising an apparatus according to the first aspect, an apparatus according to the second aspect, a data requester and a data provider.

According to a sixth aspect of the present invention, there is provided an apparatus comprising means for receiving, from a data provider, a first ciphertext, means for performing a mathematical manipulation of the first ciphertext, the mathematical manipulation modifying plaintext of the first ciphertext without decrypting the first ciphertext, the mathematical manipulation being identified by a computation identifier, means for obtaining a second ciphertext from the first ciphertext by performing a cryptographic re-encryption operation, and means for providing the second ciphertext to a first computation party.

According to a seventh aspect of the present invention, there is provided an apparatus comprising means for obtaining a key pair comprising a public key of an apparatus and a secret key of the apparatus, means for determining, based on a message from a data requester, a computation identifier, means for transmitting a request to a data service provider, the request comprising the computation identifier and a public key of the data requester, means for receiving, from the data service provider, a first ciphertext, means for obtaining a second ciphertext from the first ciphertext by performing a cryptographic re-encryption operation, and means for providing the second ciphertext to the data requester as a response to the message.

According to an eighth aspect of the present invention, there is provided a non-transitory computer readable medium having stored thereon a set of computer readable instructions that, when executed by at least one processor, cause an apparatus to at least receive, from a data provider, a first ciphertext, perform a mathematical manipulation of the first ciphertext, the mathematical manipulation modifying plaintext of the first ciphertext without decrypting the first ciphertext, the mathematical manipulation being identified by a computation identifier, obtain a second ciphertext from the first ciphertext by performing a cryptographic re-encryption operation, and provide the second ciphertext to a first computation party.

According to a ninth aspect of the present invention, there is provided a non-transitory computer readable medium having stored thereon a set of computer readable instructions that, when executed by at least one processor, cause an apparatus to at least obtain a key pair comprising a public key of an apparatus and a secret key of the apparatus, determine, based on a message from a data requester, a computation identifier, transmit a request to a data service provider, the request comprising the computation identifier and a public key of the data requester, receive, from the data service provider, a first ciphertext, obtain a second ciphertext from the first ciphertext by performing a cryptographic re-encryption operation, and provide the second ciphertext to the data requester as a response to the message.

According to a tenth aspect of the present invention, there is provided a computer program configured to cause a method in accordance with at least one of the third and fourth aspects to be performed.

### BRIEF DESCRIPTION OF THE DRAWINGS

FIG. 1 illustrates an example system in accordance with at least some embodiments of the present invention;

FIG. 2 illustrates an example system in accordance with at least some embodiments of the present invention.

FIG. 3 illustrates an example apparatus capable of supporting at least some embodiments of the present invention;

FIG. 4 illustrates signalling in accordance with at least some embodiments of the present invention;

FIG. 5 is a flow graph of a method in accordance with at least some embodiments of the present invention, and

FIG. 6 is a flow graph of a method in accordance with at least some embodiments of the present invention.

### EMBODIMENTS

Confidential processing of data in a cloud service may be obtained by dividing processing into parts, the processing being conducted on encrypted data, which is known as ciphertext. A two-level decryption process is used with two service provision entities, a data service provider and a computation party, which co-operate to jointly perform secure processing of data and deliver processed data in encrypted form to a data requesting party. The data requesting party may be a same party as the one that provided the data, that it, a data provider. At least some embodiments of the invention operate using homomorphic re-encryption.

The data service provider may receive a computation identifier and perform a mathematical manipulation of a first ciphertext, to thereby modify a plaintext underlying the first ciphertext. In other words, the data service provider may perform a computation on plaintext of the first ciphertext, without decrypting the first ciphertext, by mathematically manipulating the first ciphertext. The manipulation, and/or corresponding modification of the plaintext, is identified by the computation identifier. Subsequently, the data service provider may re-encrypt the manipulated first ciphertext to obtain a second ciphertext. The re-encrypting may comprise use of a secret key of the data service provider and a public key of a data requester, for example. The re-encrypting may be performed in dependence of the computation identifier. Re-encrypting may comprise at least partial decryption followed by encryption.

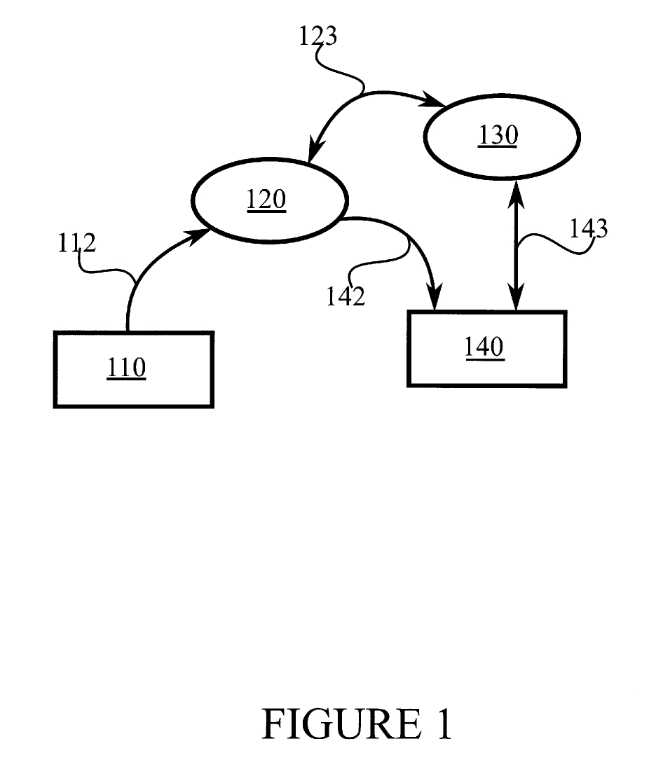

FIG. 1 illustrates an example system in accordance with at least some embodiments of the present invention. The system comprises data service provider 120, which may comprise a cloud data storage data centre or cloud data centre system, for example. Data service provider 120 may also be a cloud processing service provider. A cloud data centre system may comprise a plurality of data centres, with load balancing arranged in a suitable manner between individual data centres comprised in the plurality. In general, data service provider 120 may be configured to store data and provide some computation services.

The system of FIG. 1 further comprises at least one computation party 130. Computation party 130 may comprise a processing-enabled computing entity, such as, for example, a data centre, data centre system, server, server farm or indeed an individual networked computer such as a desktop or a laptop. In general, computation party 130 may be configured to provide data computation services and/or data access control for its users. In the model described herein, there may exist several computation parties, CP, 130 that are operated by different entities, such as medical institutions, schools, and/or banks. Different CPs may deal with different kinds of data, for example health-related data, student records and financial information. Hence, a user may freely choose a CP he trusts for service consumption. This may enhance user security.

The system of FIG. 1 further comprises at least one data provider 110. Data provider 110 may comprise a data owner, such as, for example, a consumer, corporation or government entity, for example. For example, data provider 110 may generate the data. Data may be provided by an X-ray device or body scanner where data provider 110 is a medical entity, such as a clinic or hospital. Data may be generated in an industrial process or a design tool where data provider 110 is a corporate entity, such as a manufacturer or engineering company. Data may be generated in a radar or flight control facility where data provider 110 is a government entity, such as a military or aviation authority. Data provider 110 may be configured to provide data in encrypted form to data service provider 120.

The system of FIG. 1 further comprises data requester 140. Data requester 140 may comprise an entity authorised by data provider 110 to access, at least partly, data owned and/or generated by data provider 110. Data requester 140 may need the data of data provider 110 in a processed form. Data requester 140 may be the same entity as data provider 110.

Overall, data provider 110, data service provider 120, computation party 130 and data requester 140 may be seen as roles or functions that may be assumed and performed by different kinds of entities. As indicated above, data provider 110 and data requester 140 may be one and the same. On the other hand, data service provider 120 and computation party 130 are not physically the same entity. In detail, data service provider 120 need not be trusted by data provider 110, while computation party 130 may be trusted by data provider 110.

Networked connections interconnect the entities described above to each other. In detail, connection 112 enables data provider 110 to transmit ciphertext to data service provider 120. Connection 142 enables communication between data requester 140 and data service provider 120. Connection 123 enables communication between computation party 130 and data service provider 120. Finally, connection 143 enables communication between data requester 140 and computation party 130. The connections may be wired or, at least partly, wireless, connections, where applicable.

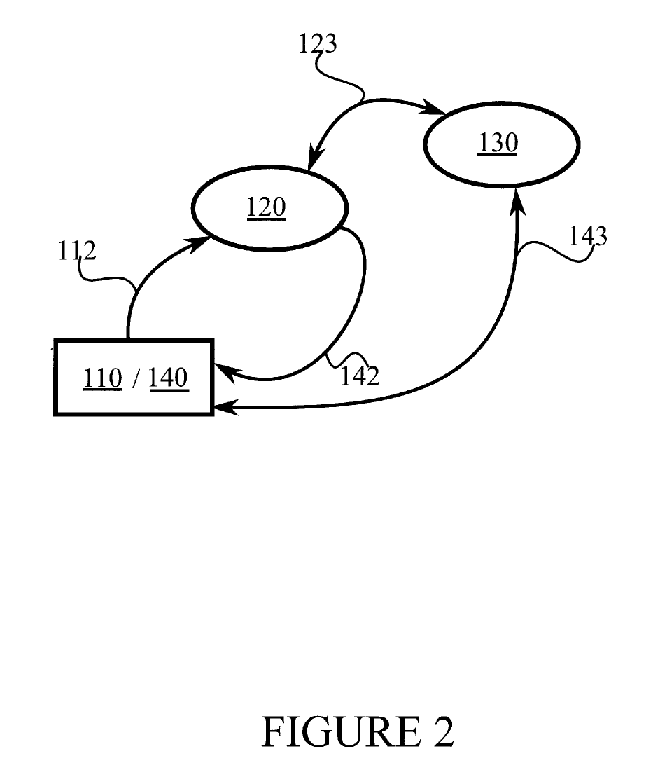

FIG. 2 illustrates an example system in accordance with at least some embodiments of the present invention. Like numbering denotes like structure as in FIG. 1. FIG. 2 corresponds to the case, where data requester 140 is the same entity as data provider 110. For example, this is the case where a data owner requests a cloud data processing result of his own data.

In the systems illustrated in FIG. 1 and FIG. 2, all entities are assumed to be curious but honest. That is, they are curious about others' data but act honestly by following the design of system protocols. In addition, the DSP 120 and the CPs 130 would be unlikely to collude with each other due to interest conflicts. Moreover, any collusion would decrease user trust in the CP 130, which leads to the loss of its users.

Three challenges are addressed by various embodiments of the present invention.

Firstly, existing ciphertext processing schemes cannot flexibly support multiparty access. Many schemes are designed based on a specified aggregator, wherein only this aggregator can access the aggregated result. Such schemes cannot support genuine multiparty access. The data provided by users cannot be used for data analysis by other authorized requesters. In some situations, data should be observed and collected all the time for potential use without knowing a concrete data access requester. For example, medical and clinical research can benefit greatly from statistics of patients. More than one party could be interested in requesting encrypted processing results after data collection and process. Hence, such an application scenario calls for a privacy-preserving data processing scheme for multiple unspecified requesters. However, existing work cannot support this demand in a flexibly and efficient way.

Secondly, it is desired that ciphertext processing results should be only accessed by authorized requesters. A data processing party, such as a cloud service provider, should not be able to access the results if it cannot be fully trusted by the data owner. The problem of privacy-preserving data aggregation with a distrusted aggregator has been studied, but such studies only describe systems that allow the aggregator to access the final aggregated results. Such schemes cannot satisfy the practical security requirement.

Thirdly, most existing research focuses on encrypted data aggregation and multiplication, which cannot support various computation operations over the same encrypted outsourced data. Aggregation and multiplication of encrypted data are not sufficient to satisfy emerging demands on data analytics in our daily life. Fully homomorphic encryption could support various computations of encrypted data, but it cannot flexibly control multiparty access on the processed data in an encrypted form because the finally processed data can only be decrypted with a corresponding secret key.

To solve the above-described three problems, a re-encryption scheme is proposed, which can flexibly support access control on encrypted-data computation results with two-level decryption. Furthermore, the proposed re-encryption scheme is applied to realize a number of operations over ciphertexts including addition, subtraction, multiplication, sign acquisition, comparison, equivalent test, and variance, which may support various applications that request processing of encrypted data and/or analytics thereof.

We consider a scenario with two types of independent service providers that do not collude with each other. One is data service provider, DSP, 120 that is responsible for data storage and partial computations. The other is computation party, CP, 130 that is in charge of data access control and additional computations. DSP 120 collects and stores the data in an encrypted form from a number of data providers, DP, 110. When a data requester, DR, 140, requires a data processing result, CP 130 may first check an access right of DR 140. If DR 140 is eligible to access the data, CP 130 contacts DSP 120 to further process the ciphertext with a re-encryption process for the DR 140, and then CP 130 may provide the re-encryption result to the authorized DR 140 for decryption. In addition, the described scheme supports multiple CPs 130 served by different companies for distributed data processing and access control. In general, DSP 120 and CP 130 together produce the ciphertext, with contents of the ciphertext processed as requested by DR 140, such that DSP 120 does not obtain access to the contents of the ciphertext despite DSP 120 participating in performing the requested processing.

Specifically, the contributions of this invention can be summarized as the following three elements:

Firstly, a new cryptographic primitive is described, which uses two service providers, DSP 120 and CP 130, to manage encrypted data and realizes re-encryption over homomorphic encryption. The primitive enables processing and analysis of ciphertext. Only authorized users can access the encrypted data processing result in a secure way.

Secondly, seven basic operations on encrypted data based on the primitive are described: addition, subtraction, multiplication, sign acquisition, comparison, equivalent test, and variance, which can satisfy many data processing demands.

Thirdly, to enhance the flexibility and security of the proposed schemes, we apply multiple CPs to take in charge of the data from their own customers and design computing operations over ciphertexts belonging to multiple CPs.

Paillier's cryptosystem, as described in Paillier: “Public key cryptosystems based on composite degree residuosity classes” (Advances in cryptology, EUROCRYPT 1999, pp. 223-238) is one of the most important additive homomorphic encryption systems. Suppose we have N encrypted data under same key pk, which can be presented as [mᵢ]ₚₖ (i=1, 2, . . . , N). The additive homomorphic encryption satisfies the following equation:

Dₛₖ(Πᵢ₌₁^{N}[mᵢ]ₚₖ)=Σᵢ₌₁^{N}mᵢ

where Dₛₖ( ) is the corresponding homomorphic decryption algorithm with secret key sk. Reference is made to Paillier (see above), EIGamal “A public key cryptosystem and a signature scheme based on discrete algorithms” (Advances in cryptology, Springer, 1985, pp 10-18.) and Bresson et al. “A simple public-key cryptosystem with a double trapdoor decryption mechanism and its applications”, (Advances in cryptology, ASIACRYPT 2003, Springer, pp. 37-54).

For easy presentation, we use the acronym EDD to present the mechanism proposed by E. Bresson, D. Catalano and D. Pointcheval: “A simple public-key cryptosystem with a double trapdoor decryption mechanism and its applications” (Advances in Cryptology, ASIACRYPT, 2003, pp. 37-54, Springer, 2003), which is a variant of Cramper-Shoup “Universal hash proofs and a paradigm for adaptive chosen ciphertext secure public-key encryption” (Advances in cryptology, EUROCRYPT 2002, pp. 45-64).

Let g and h be two elements of maximal order in [symbol] . Note that, if h is computed as g^{x}, where x∈_{R} [1, λ(n²)], then x is coprime with ord( [symbol] ) with high probability, and thus h is of maximal order.

Key Generation: The public parameters are n, g and h=g^{x} by randomly choosing a value x∈[1, ord( [symbol] )] (where g is generated by first choosing a random element α∈ [symbol] ₙ_{²}*, and then setting g=α² mod n²).

Encrypt: Given a message m∈ [symbol] ₙ, random number r is chosen uniformly in [symbol] ₙ_{²}*. The ciphertext is computed as (T, T′)={h^{r}(1+m*n) (mod n²), g^{r}(mod n²)}.

Decryption: Knowing x, one can obtain m as follows:

m=L(T/(T′)^{x} mod n²), where L(u)=(u−1)/n.

Note: if the factorization of n=p*q (λ(n)=(p−1)(q−1)/2) is given, one can directly decrypt the ciphertext by computing m=L((T)^{λ(n)})[λ(n))]⁻¹ mod n.

In this section, we briefly introduce the original attempt of proxy re-encryption, PRE, in Ateniese et al. “Improved proxy re-encryption schemes with applications to secure distributed storage” (ACM Transactions on Information and System Security (TISSEC), vol. 9, no. 1, pp. 1-30, 2006), which lays the foundation of our proposed schemes. Generally, the ciphertext that can be only decrypted by Entity A can be converted into the one that can be decrypted by Entity B through the re-encryption of a proxy.

The PRE is based on Cramper-Shoup and EDD. It has the same operation of key generation as EDD. Thus, we skip it and focus on re-encryption operation.

Data Encryption: to encrypt a message m∈ [symbol] ₙ, select a random r∈[1, n/4] and compute: (T, T′)={h^{r}(1+m*n)(mod n²), g^{r}}.

Decryption with x: m=L(T/(T′)^{x} mod n²), where L(u)=(u−1)/n, for all u∈{u<n²|u=1 mod n}.

Proxy Re-encryption: the secret key x is divided into two shares x₁ and x₂, such that x=x₁+x₂. The share x₁ is given to the proxy, while x₂ is kept by Entity B.

Re-encryption (done by the proxy): (\tilde{T}, [symbol] )=(T/(T′)^{x}^{₁}, T′)=(h^{r}(1+m*n)(mod n²)/(g^{r})^{x}^{₁}, g^{r});

Decryption (done by Entity B): m=L(\tilde{T}/( [symbol] )^{x}^{₂} mod n²).

This is a proxy-invisible scheme, which means that it is unable to distinguish the original ciphertext from the re-encrypted ciphertext. In our proposed scheme, two servers play as an invisible proxy to transfer the encrypted data to the ciphertext under the key of an authorized requester. Moreover, the non-colluding servers help ensure the correct transformation of ciphertext.

The following table summarizes notation used herein:

| Symbols | Description |
|---|---|
| g | The system generator that is public; |
| n | The system parameter; |
| (SK_{DSP}, PK_{DSP}) | The key pair of DSP; |
| (SK_{CP}, PK_{CP}) | The key pair of CP |
| $PK = {PK}_{DSP}^{{SK}_{CP}} = {PK}_{CP}^{{SK}_{DSP}}$ | The public parameter based on keys of DSP and CP; |
| (skⱼ, pkⱼ) | The key pair of DR j; |
| (skᵢ, pkᵢ) | The key pair of DP i; |
| mᵢ | The raw data provided by DP i; |
| [m] | The ciphertext of m under PK; |
| [m]⁺ | The re-encryption result of m by DSP; |
| [m]ₚₖ_{ᵢ} | The ciphertext of m under pkᵢ; |
| r | The random number; |
| r_{*} | The random number chosen for encryption; |
| CID | The public computation identifier, which |
| | is related to the operation type; |
| N | The number of data providers; |
| [symbol] (*) | The bit length of input data; |
| H( ) | The hash function; |
| [symbol] | The set of data providers related to CID; |
| \| [symbol] \| | The number of providers in [symbol] . |

In order to support privacy-preserving data processing, we adapt the EDD to encrypt personal data with the Diffie-Hellman key of two servers, i.e., PK=PK_{DSP}^{SK}^{_{CP}}=PK_{CP}^{SK}^{_{DSP}}. We design the primitive, HRES, which can realize proxy-invisible re-encryption and secure data processing. The HRES consists of the following algorithms:

KeyGen: Let k be a security parameter and p, q be two large primes, where [symbol] (p)= [symbol] (q)=k( [symbol] (⋅) returns the bit length of input data). Due to the property of safe primes, there exist two primes p′ and q′ which satisfy that p=2p′+1, q=2q′+1. We compute n=p*q and choose a generator g with order λ=2p′q′, which can be chosen by selecting a random number z∈ [symbol] ₙ_{²}* and computing g=−z²ⁿ. The value λ can be used to decrypt the encrypted data, but we choose to conceal it and protect it from all involved parties. In the HRES, we only use key pair (sk, g^{sk}) for data encryption and decryption. The DSP 120 and the CP 130 generate their key pairs: (SK_{DSP}=a, PK_{DSP}=g^{a}) and (SK_{CP}=b, PK_{CP}=g^{b}), and then negotiate their Diffie-Hellman key PK=PK_{DSP}^{SK}^{_{CP}}=PK_{CP}^{SK}^{_{DSP}}=g^{a*b}. To support encrypted data processing, PK is public to all involved parties. Cloud user i generates its key pair (skᵢ, pkᵢ)=(kᵢ, g^{k}^{ᵢ}). The public system parameters include {g, n, PK}.

First, the Original Encryption scheme is directly obtained from EDD.

Encryption (Enc): For a personal purpose, a user can outsource private data with its own key pair, which can ensure the unavailability of data to other entities. It can also be used to send data to a specified target. User encrypts their data with the public key of user i and a random r⊂[1, n/4] as follows:

[m]ₚₖ_{ᵢ}=((1+m*n)pkᵢ^{r}, g^{r})(mod n²).

Decryption (Dec): Upon receiving the encrypted data under its own public key, user i can directly decrypt it to obtain the original data:

$$m = L ( \frac{( 1 + m * n ) {pk}_{i}^{r}}{{( {g}^{r} )}^{{k}_{i}}} mod {n}^{2} )$$

Second, the following encryption is a Two-Level Decryption scheme that can support outsourced data processing flexibly.

Encryption with Two Keys (EncTK): To support ciphertext process flexibly, we propose to encrypt original data under the keys of two servers. Given a message mᵢ∈ [symbol] ₙ provided by user i, we first select a random number r∈[1, n/4] and then encrypt it with PK. The ciphertext is generated as [mᵢ]={Tᵢ, Tᵢ′}, where Tᵢ′=g^{r} mod n², Tᵢ=(1+mᵢ*n)*PK^{r} mod n².

Note: [mᵢ] denotes the ciphertext of mᵢ encrypted with PK, which can only be decrypted under the cooperation of the DSP and the CP. [mᵢ]ₚₖ_{ᵢ} denotes the data that is encrypted with pkᵢ, which can be decrypted by user i.

Partial Decryption with SK_{DSP} (PDec1): Once [mᵢ] is received by the DSP, algorithm PDec1( ) will be run to transfer it into another ciphertext which can be decrypted by the CP as follows:

$$\begin{matrix}{[ {m}_{i} ]}_{{PK}_{CP}} = \{ {T}_{i}^{( 1 )} , {T}_{i}^{′ ( 1 )} \} \\ = \{ {T}_{i} , {( {T}_{i}^{′} )}^{{SK}_{DSP}} \} \\ = \{ ( 1 + {m}_{i} * n ) {PK}^{r} mod {n}^{2} , {g}^{r * a} mod {n}^{2} \} \\ = \{ ( 1 + {m}_{i} * n ) {PK}_{CP}^{a * r} mod {n}^{2} , {g}^{r * a} mod {n}^{2} \} .\end{matrix}$$

Partial Decryption with SK_{CP} (PDec2): Once the message [mᵢ]_{PK}_{_{CP}} is received, the CP can directly decrypt it with its own secret key as follows:

1) Select the public computation identifier CID, which specifies the operation type.

2) h₁=H ((pkⱼ)^{SK}^{_{DSP}}∥CID);

3) [mᵢ]⁺={\tilde{T}, [symbol] }={Tᵢ, (Tᵢ′)^{SK}^{_{DSP}}*g^{h}^{₁}}.

To achieve the proxy-invisible re-encryption, we further propose a Somewhat Re-Encryption scheme, wherein differently from the scheme described above, it aims to transfer the encrypted data to the ciphertext under the public key of an authorized requester. Here, we assume DR j with key pair (skⱼ, pkⱼ)=(t, g^{t}) requires to obtain mᵢ through outsourced data [mᵢ]. In our scheme, the transformation needs the cooperation and recognition of both the DSP and the CP. They together play the role of a proxy.

First Phase of Re-Encryption (FPRE): In order to prevent the decryption PDec2( ) by the CP, the DSP initiates algorithm FPRE( ) as follows:

1) Select the public computation identifier CID, which specifies the operation type.

2) h₁=H ((pkⱼ)^{SK}^{_{DSP}}∥CID);

3) [mᵢ]⁺={\tilde{T}, [symbol] }={Tᵢ, (Tᵢ′)^{SK}^{_{DSP}}*g^{h}^{₁}}. Notes: [mᵢ]⁺ denotes the encrypted data that can only be decrypted by an authorized data requester with the support of the CP 130.

Second Phase of Re-Encryption (SPRE): Upon receiving the data packet [mᵢ]⁺, the CP launches re-encryption algorithm SPRE( ) as below:

1) h₂=H ((pkⱼ)^{SK}^{_{CP}}∥CID;

2) [mᵢ]ₚₖ_{ⱼ}={T̅, T̅′}={\hat{T}, ( [symbol] )^{SK}^{_{CP}}*g^{h}^{₂}}. Note: If data outsourced by a user are extremely private and not allowed to be processed or analyzed, the cloud user can choose to use Enc( ) to encrypt its personal data with its own public key and then store them at the DSP. If the data can be analyzed in a privacy-preserving way by authorized parties, the user need to store encrypted data by calling the encryption algorithm EncTK( ).

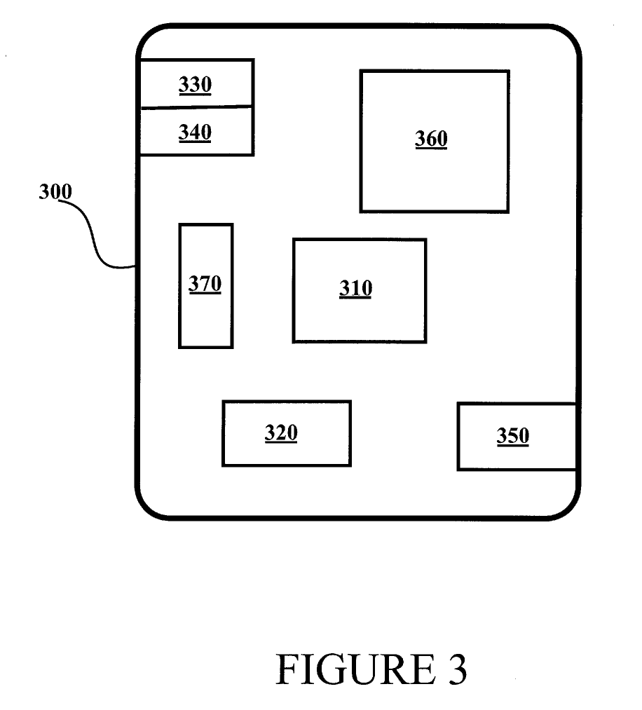

FIG. 3 illustrates an example apparatus capable of supporting at least some embodiments of the present invention. Illustrated is device 300, which may comprise, for example, a DP 110, DSP 120, CP 130 or DR 140 of FIG. 1 or FIG. 2. Comprised in device 300 is processor 310, which may comprise, for example, a single- or multi-core processor wherein a single-core processor comprises one processing core and a multi-core processor comprises more than one processing core. Processor 310 may comprise more than one processor. A processing core may comprise, for example, a Cortex-A8 processing core manufactured by ARM Holdings or a Steamroller processing core produced by Advanced Micro Devices Corporation. Processor 310 may comprise at least one Qualcomm Snapdragon and/or Intel Atom processor. Processor 310 may comprise at least one application-specific integrated circuit, ASIC. Processor 310 may comprise at least one field-programmable gate array, FPGA. Processor 310 may be means for performing method steps in device 300. Processor 310 may be configured, at least in part by computer instructions, to perform actions.

Device 300 may comprise memory 320. Memory 320 may comprise random-access memory and/or permanent memory. Memory 320 may comprise at least one RAM chip. Memory 320 may comprise solid-state, magnetic, optical and/or holographic memory, for example. Memory 320 may be at least in part accessible to processor 310. Memory 320 may be at least in part comprised in processor 310. Memory 320 may be means for storing information. Memory 320 may comprise computer instructions that processor 310 is configured to execute. When computer instructions configured to cause processor 310 to perform certain actions are stored in memory 320, and device 300 overall is configured to run under the direction of processor 310 using computer instructions from memory 320, processor 310 and/or its at least one processing core may be considered to be configured to perform said certain actions. Memory 320 may be at least in part comprised in processor 310. Memory 320 may be at least in part external to device 300 but accessible to device 300.

Device 300 may comprise a transmitter 330. Device 300 may comprise a receiver 340. Transmitter 330 and receiver 340 may be configured to transmit and receive, respectively, information in accordance with at least one cellular or non-cellular standard. Transmitter 330 may comprise more than one transmitter. Receiver 340 may comprise more than one receiver. Transmitter 330 and/or receiver 340 may be configured to operate in accordance with global system for mobile communication, GSM, wideband code division multiple access, WCDMA, long term evolution, LTE, IS-95, wireless local area network, WLAN, Ethernet and/or worldwide interoperability for microwave access, WiMAX, standards, for example.

Device 300 may comprise a near-field communication, NFC, transceiver 350. NFC transceiver 350 may support at least one NFC technology, such as NFC, Bluetooth, Wibree or similar technologies.

Device 300 may comprise user interface, UI, 360. UI 360 may comprise at least one of a display, a keyboard, a touchscreen, a vibrator arranged to signal to a user by causing device 300 to vibrate, a speaker and a microphone. A user may be able to operate device 300 via UI 360, for example to manage ciphertext-form data.

Device 300 may comprise or be arranged to accept a user identity module 370. User identity module 370 may comprise, for example, a subscriber identity module, SIM, card installable in device 300. A user identity module 370 may comprise information identifying a subscription of a user of device 300. A user identity module 370 may comprise cryptographic information usable to verify the identity of a user of device 300 and/or to facilitate encryption of communicated information and billing of the user of device 300 for communication effected via device 300.

Processor 310 may be furnished with a transmitter arranged to output information from processor 310, via electrical leads internal to device 300, to other devices comprised in device 300. Such a transmitter may comprise a serial bus transmitter arranged to, for example, output information via at least one electrical lead to memory 320 for storage therein. Alternatively to a serial bus, the transmitter may comprise a parallel bus transmitter. Likewise processor 310 may comprise a receiver arranged to receive information in processor 310, via electrical leads internal to device 300, from other devices comprised in device 300. Such a receiver may comprise a serial bus receiver arranged to, for example, receive information via at least one electrical lead from receiver 340 for processing in processor 310. Alternatively to a serial bus, the receiver may comprise a parallel bus receiver.

Device 300 may comprise further devices not illustrated in FIG. 3. For example, where device 300 comprises a smartphone, it may comprise at least one digital camera. Some devices 300 may comprise a back-facing camera and a front-facing camera, wherein the back-facing camera may be intended for digital photography and the front-facing camera for video telephony. Device 300 may comprise a fingerprint sensor arranged to authenticate, at least in part, a user of device 300. In some embodiments, device 300 lacks at least one device described above. For example, some devices 300 may lack a NFC transceiver 350 and/or user identity module 370.

Processor 310, memory 320, transmitter 330, receiver 340, NFC transceiver 350, UI 360 and/or user identity module 370 may be interconnected by electrical leads internal to device 300 in a multitude of different ways. For example, each of the aforementioned devices may be separately connected to a master bus internal to device 300, to allow for the devices to exchange information. However, as the skilled person will appreciate, this is only one example and depending on the embodiment various ways of interconnecting at least two of the aforementioned devices may be selected without departing from the scope of the present invention.

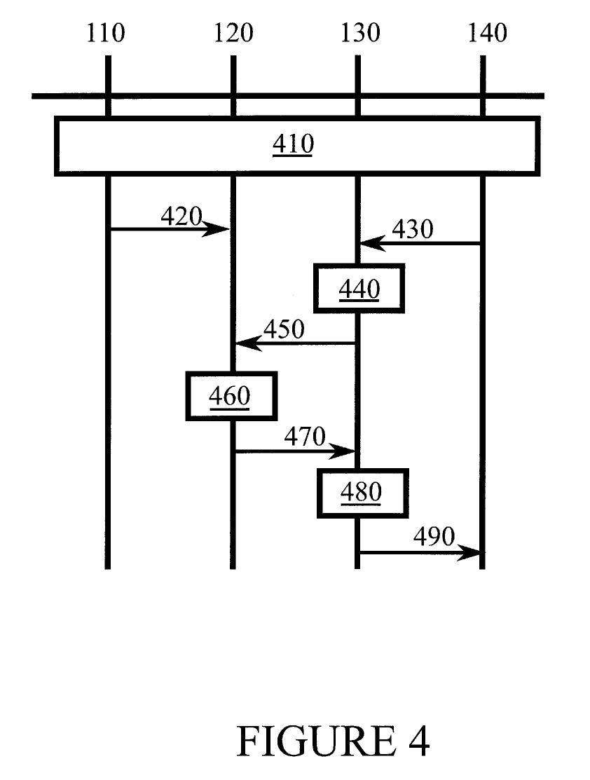

FIG. 4 illustrates signalling in accordance with at least some embodiments of the present invention. On the vertical axes are disposed, from the left to the right, DP 110, DSP 120, CP 130 and DR 140. Time advances from the top toward the bottom.

Phase 410, which takes place in all the four entities, comprises a system setup phase. DSP 120 and CP 130 get their own key pairs respectively (SK_{DSP}, PK_{DSP})=(a, g^{a}) and (SK_{CP}, PK_{CP})=(b, g^{b}), and then negotiate PK=PK_{CP}^{SK}^{_{DSP}}=PK_{DSP}^{SK}^{_{CP}}=g^{a*b}. The corresponding secret key of PK is a*b. DP 110, that is, user i, generates its own key pair (skᵢ, pkᵢ)=(kᵢ, g^{k}^{ᵢ}) by randomly choosing kᵢ∈[1, n/4], and then registers at the CP. The public parameters are (n, g, PK, [symbol] (n)) and the public keys of all involved entities. DR 140 j performs similarly to generate its key pair (skⱼ, pkⱼ)=(kⱼ, g^{k}^{ⱼ})=(t, g^{t}). If multiple CPs 130 are employed in the system, each CP 130 may negotiate a Diffie-Hellman key with the DSP 120 and publish this key to its customers. For simplifying presentation, we only present the detailed operations in the case that there is only one CP 130 interacting with the DSP 120 as below.

Phase 420 comprises a data upload from DP 110 to DSP 120. DPs 110 encrypt their data before uploading it to the DSP 120. DP i 110 calls EncTK( ) to encrypt data mᵢ:

[mᵢ]=(Tᵢ, Tᵢ′)={(1+mᵢ*n)*PK^{r}^{ᵢ} mod n², g^{r}^{ᵢ} mod n²}.

For correctly supporting various computations, the length of the data may be restricted [symbol] (mᵢ)< [symbol] (n)/4. Then DP i 110 uploads and stores [mᵢ] at the DSP 120.

Phase 430 comprises DR 140 requesting the data uploaded in phase 420, by signalling to CP 130. The request of phase 430 may comprise a computation identifier, CID. The request may comprise a request to obtain the data in processed and encrypted form. The request may comprise a public key of DR 140.

Phase 440 may comprise CP 130 assessing, whether DR 140 is authorized to access the data. In case no, processing may stop here. In case DR 140 is authorized, CP 130 may forward the request to DSP 120, the forwarding being illustrated in FIG. 4 as phase 450. The forwarded request may likewise comprise the CID, and/or a public key of DR 140.

Phase 460 comprises DSP 120 pre-processing the requested data, upon receiving the request from DR 140 authorized by CP 130, according to the computation identifier CID by calling the algorithm FPRE( ), which is described above, to prepare data packet DPacket for CP 130. Phase 470 comprises DSP 120 providing the processed data, DPacket, to CP 130. Phase 460 may further comprise DSP 120 performing a mathematical manipulation of the data in encrypted form, in dependence of the CID.

Phase 480 comprises CP 130 further processing DPacket, received from DSP 120, by calling the algorithm SPRE( ) to obtain DPacket′. Algorithm SPRE( ) is described above. Alternatively, phase 480 may comprise CP 130 transferring DPacket under DR 140's public key using a different method, such as by first using PDec2( ) and then Enc( ).

These algorithms are described above. Finally, in phase 490, DPacket′ is provided to DR 140 as a response to the request of phase 430. Once DR 140 has DPacket′, it may decrypt it, for example by calling algorithm DPRE( ) to obtain the data. DPRE( ) is described above.

In the following, processing of encrypted data will be described with respect to the computations listed above, namely The HRES primitive may support seven basic operations, indicated by different CID: 1) addition; 2) subtraction; 3) multiplication; 4) sign acquisition; 5) comparison; 6) equivalent Test; and 7) variance.

System setup and data collection have no difference from that in FIG. 4. Hence, we ignore the process of data upload and mainly focus on phases 460, 480 and 490 in the following presentation. DP i 110 offers personal data as [mᵢ] and DR j 140 holds the key pair (skⱼ, pkⱼ)=(kⱼ, g^{k}^{ⱼ})=(t, g^{t}).

Addition: this scheme aims to obtain the sum of all raw data (m= [symbol] mᵢ) where [symbol] represents the set of data providers related to CID in the request.

Phase 460 (Data Preparation at DSP): Due to the additive homomorphism, the DSP can directly multiply encrypted data one by one as following:

[m]=(T, T′)=( [symbol] Tᵢ, [symbol] Tᵢ′).

To transfer it into the ciphertext under DR j's public key, the DSP further calls the algorithm FPRE( ) to process the data with its own secret key and DR j's public key pkⱼ:

[m]⁺=(\tilde{T}, [symbol] )={T, (T′)^{a}*g^{H((pk}^{ⱼ}⁾^{^{a}}^{∥CID)}}.

The DSP finally prepares a data packet ([m]⁺, CID) and sends it to the CP.

Phase 480 (Data Process at CP): The CP calls the second re-encryption algorithm SPRE( ) to finally transfer the encrypted data to the ciphertext under DR j's public key:

[m]ₚₖ_{ⱼ}=(T̅, T̅′)={\hat{T}, ( [symbol] )^{b}*g^{H((pk}^{ⱼ}⁾^{^{b}}^{∥CID)}}.

Then the CP sends ([m]ₚₖ_{ⱼ}, CID) to the DR.

Phase 490 (Data Access at DR): The DR can obtain the aggregated result by calling the algorithm DPRE( ):

m=L(T̅*PK_{CP}^{H((PK}^{_{DSP}}⁾^{^{sk}}^{ⱼ}^{∥CID)}*g^{H((PK}^{_{CP}}⁾^{^{sk}}^{ⱼ}^{∥CID)}/T̅′ mod n²).

Subtraction: this function aims to obtain the subtraction of some data (for example, m=m₁−m₂) with encrypted data [m₁] and [m₂]. The HRES has an additional property as follows:

[mᵢ]ⁿ⁻¹={{(1+mᵢ*n)PK^{r}^{ᵢ}}⁽ⁿ⁻¹⁾, (g^{r}^{ᵢ})⁽ⁿ⁻¹⁾}={(1+mᵢ(n−1)*n)PK^{r}^{ᵢ}⁽ⁿ⁻¹⁾, g^{r}^{ᵢ}⁽ⁿ⁻¹⁾}={(1−mᵢ*n)PK^{r}^{ᵢ}⁽ⁿ⁻¹⁾, g^{r}^{ᵢ}⁽ⁿ⁻¹⁾}mod n²=[−mᵢ]

Phase 460 (Data Preparation at DSP): The DSP first computes [−m₂]=[m₂]ⁿ⁻¹, and then multiplies it with [m₁] to obtain [m]=[m₁−m₂].

Then the subsequent process is the same as that in Addition. For length and simplicity reasons, we skip its details.

Multiplication: This function aims to obtain the product of all raw data (m= [symbol] mᵢ). For ease of presentation, we describe the details with two pieces of data ([m₁], [m₂]). The DR wants to get the multiplication result m=m₁*m₂.

Note that the available number of the data in multiplication influences the length of raw data. If we need to get the product of f pieces of data, it must be guaranteed that the length of each raw data [symbol] (mᵢ)< [symbol] (n)/(2f).

Phase 460 (Data Preparation at DSP): First, the DSP chooses two random numbers c₁, c₂ (the number of random numbers is equal to that of provided data) and sets another one c₃=(c₁*c₂)⁻¹ mod n.

To conceal each raw data from the CP, the DSP does one exponentiation and one decryption with its own secret key by calling PDec1( ). Then the DSP encrypts c₃ with Enc( ) using the public key pkⱼ of the requesting DR:

[c₁*m₁]={T₁, (T₁′)^{c}^{₁}}

[c₁*m₁]_{PK}_{_{CP}}=(T₁⁽¹⁾, T₁′⁽¹⁾)={T₁^{c}^{₁}, (T₁′)^{c}^{₁}^{*a}}={(1+c₁*m₁*n)*PK^{r}^{₁}^{*c}^{₁}, g^{r}^{₁}^{*a*c}^{₁}}

[c₂*m₂]={T₂, (T₂′)^{c}^{₂}}

[c₂*m₂]_{PK}_{_{CP}}=(T₂⁽¹⁾, T₂′⁽¹⁾)={T₂^{c}^{₂}, (T₂′)^{c}^{₂}^{*a}}={(1+c₂*m₂*n)*PK^{r}^{₂}^{*c}^{₂}, g^{r}^{₂}^{*a*c}^{₂}}

[c₃]ₚₖ_{ⱼ}=(Tⱼ, Tⱼ′)={(1+c₃*n)*pkⱼ^{r}^{₃}, g^{r}^{₃}}

The data packet sent to the CP 130 is {[c₁*m₁]_{PK}_{_{CP}}, [c₂*m₂]_{PK}_{_{CP}}, [c₃]ₚₖ_{ⱼ}}.

Phase 480 (Data Process at CP): Upon receiving the data packet from the CSP, the CP uses the algorithm PDec2( ) to decrypt the data:

c₁*m₁=T₁⁽¹⁾/(T₁′⁽¹⁾)^{b},

c₂*m₂=T₂⁽¹⁾/(T₂′⁽¹⁾)^{b},

It further multiplies the two values and then calls Enc( ) to encrypt it as (T, T′)=[c₁*c₂*m₁*m₂]ₚₖ_{ⱼ}. Finally, the CP 130 forwards (T, T′) and [c₃]ₚₖ_{ⱼ} to the DR 140.

Phase 490 (Data Access at DR): the DR 140 can obtain the product by calling Dec( ) to decrypt the two ciphertexts with its secret key:

$$m = {m}_{1} * {m}_{2} = L ( \frac{T}{{( {T}^{′} )}^{{sk}_{j}}} mod {n}^{2} ) * L ( \frac{{T}_{j}}{{( {T}_{j}^{′} )}^{{sk}_{j}}} mod {n}^{2} ) mod n .$$

Sign Acquisition: As [symbol] (m)< [symbol] (n)/4, we assume that BIG is the largest raw data of m. Then the raw data is in the scope [−BIG, BIG]. DR j wants to know the sign of raw data m₁ from [m₁].

Phase 460 (Data Preparation at DSP): The DSP chooses a random number c₁ where [symbol] (c₁)< [symbol] (n)/4. It first computes

$$\begin{matrix}[ 2 * {m}_{1} + 1 ] = ( T , {T}^{′} ) \\ = \{ {T}_{1}^{2} * ( 1 + n ) * {PK}^{{r}^{′}} , {T}_{1}^{′2} * {g}^{r ′} \} \\ = \{ ( 1 + ( 2 * {m}_{1} + 1 ) * n ) * {PK}^{r ′ + 2 * {r}_{1}} , {g}^{{r}^{′} + 2 * {r}_{1}} \}\end{matrix}$$

Then it flips a coins s. If s=0; it computes as follows: (T₁⁽¹⁾, T₁′⁽¹⁾)={T^{n-c}^{₁}, (T′)^{a*(n-c}^{₁}⁾}=[−c₁*(2*m₁+1)]. Otherwise, it calls PDec1( ) and computes: (T₁⁽¹⁾, T₁′⁽¹⁾)={T^{c}^{₁}, T′^{a*c}^{₁}}=[c₁*(2*m₁+1)].

The DSP also encrypts s with pkⱼ through Enc( ): [s]ₚₖ_{ⱼ}=(Tₛ, Tₛ′)={(1+s*n)*pkⱼ^{r}^{ₛ}, g^{r}^{ₛ}}. The data packet sent to the CP is {(T₁⁽¹⁾, T₁′⁽¹⁾), [s]ₚₖ_{ⱼ}}.

Phase 480 (Data Process at CP): Upon receiving the data packet from the DSP 120, the CP 130 decrypts (T₁⁽¹⁾, T₁′⁽¹⁾) with PDec2( ) to obtain raw data m′=(−1)^{s+1}*c₁*(2*m₁+1) mod n². The CP compares [symbol] (m′) with [symbol] (n)/2. If [symbol] (m′)< [symbol] (n)/2, it calls Enc( ) to encrypt u=1 with pkⱼ; otherwise, it encrypts u=0 with pkⱼ;

[u]ₚₖ_{ⱼ}=(Tᵤ, Tᵤ′)={(1+u*n)*pkⱼ^{r}^{ᵤ}, g^{r}^{ᵤ}}

It further multiplies the two ciphertexts.

[s+u]ₚₖ_{ⱼ}=(T, T′)={Tₛ*Tᵤ, Tᵤ′*Tₛ′}. Finally, the CP forwards (T, T′) to DR j.

Phase 490 (Data Access at DR): DR j can call Dec( ) to obtain the final result: u+s=L(T/(T′)^{sk}^{ⱼ} mod n²). Then DR j needs to check it and determine the sign of raw data: if u+s=1, the original data is negative (i.e., m₁<0); otherwise, it is positive or zero (i.e., m₁≥0). Note: if (s=1, u=0) or (u=1, s=0), m₁<0; if (s=1, u=1) or (u=0, s=0), m₁≥0.

Comparison: Similar to the schemes above, DR j wants to compare the raw data (m₁, m₂) based on their encrypted data. For ease of presentation, m₁−m₂ is denoted as m₁₋₂.

[m₁]=(T₁, T₁′)={(1+m₁*n)*PK^{r}^{₁}, g^{r}^{₁}}

[m₂]=(T₂, T₂′)={(1+m₂*n)*PK^{r}^{₂}, g^{r}^{₂}}

Phase 460 (Data Preparation at DSP): DSP first computes to get the subtraction of encrypted data:

(T, T′)={T₁*(T₂)ⁿ⁻¹, T₁′*(T₂′)ⁿ⁻¹}=[(m₁−m₂)].

The following steps are the same to that in Sign Acquisition, which is skipped for the reason of length limitation. Through the cooperation of the DSP 120 and the CP 130, the DR 140 finally gets the sign of m₁₋₂=m₁−m₂. In the end, the DR can obtain the comparison result. If m₁₋₂≥0, m₁≥m₂; otherwise, m₁<m₂.

Equivalent test: If DR j 140 wants to know if m₁ is equal to m₂ with encrypted data ([m₁], [m₂]). The DSP 120 and the CP 130 directly interact with each other in two parallel computations of Comparison.

They compare m₁ and m₂ in two forms: 1) m₁₋₂=m₁−m₂; 2) m₂₋₁=m₂−m₁. Through the operations in Comparison, DSP can get two computation results [s₁+u₁]ₚₖ_{ⱼ} and [s₂+u₂]ₚₖ_{ⱼ} respectively.

To conceal the comparing result of m₁ and m₂, [s₁+u₁]ₚₖ_{ⱼ} and [s₂+u₂]ₚₖ_{ⱼ} are sent to the DR in a random order. If both testing result are “≥”, we can know m₁=m₂.

Variance: In some scenarios, DR j 140 may want to get the variance of some data according to provided encrypted data. In this presentation, we set N be the number of provided data and m=Σᵢ₌₁^{N} mᵢ. Variance function can be presented as

$$M = \frac{{\sum }_{i = 1}^{N} {( {m}_{i} - \overline{m} )}^{2}}{N} = \frac{{\sum }_{i = 1}^{N} {( N * {m}_{i} - m )}^{2}}{{N}^{3}} ,$$

where m̅ is the average of mᵢ (i=1, . . . , N). For ease of presentation, we assume there are three pieces of encrypted data (i.e., N=3): [m₁], [m₂] and [m₃].

Phase 460 (Data Preparation at DSP): First, the DSP 120 obtains [N*mᵢ−Σᵢ₌₁^{N} mᵢ] through following steps:

[m]=(T ,T′)=[m₁]*[m₂]*[m₃],

[−m]=(Tⁿ⁻¹, (T′)ⁿ⁻¹);

[N*mᵢ]=[mᵢ]^{N} for i=1,2,3;

[N*mᵢ−m]=[mᵢ]^{N}*[−m] for i=1,2,3;

Then the DSP 120 partially decrypts the data with its secret key by calling PDec1( ) to obtain: [N*mᵢ−m]_{PK}_{_{CP}} for i=1,2,3. The DSP 120 chooses three random numbers c₁, c₂, c₃, and computes to obtain:

[cᵢ(N*mᵢ−m)]_{PK}_{_{CP}}=([N*mᵢ−m]_{PK}_{_{CP}})^{c}^{ᵢ} for i=1,2,3

Then the DSP 120 send the three ciphertexts to the CP 130. In addition, DSP 120 needs to store c₁², c₂², c₃².

Phase 480 (Data Process at CP): Upon receiving the data from the DSP, the CP directly decrypts to obtain raw data and then processes the data for DR j as follows:

Decrypt to obtain: Cᵢ=cᵢ(N*mᵢ−m) for i=1,2,3;

Encrypt processed data with the public key pkⱼ of DR j 140:

[Cᵢ²]ₚₖ_{ⱼ}=[cᵢ²(N*mᵢ−m)²]ₚₖ_{ⱼ} for i=1,2,3. Then CP 130 sends them back to DSP 120. Additional Operation at DSP: The DSP first computes the reverse of c₁², c₂², c₃² respectively: cᵢ′=(cᵢ²)⁻¹ mod n² for i=1,2,3. Then DSP 120 can prepare the final result for DR j:

$$\begin{matrix}{[ {M}^{′} ]}_{{pk}_{j}} = {( {[ {C}_{1}^{2} ]}_{{pk}_{j}} )}^{{c}_{1}^{′}} * {( {[ {C}_{2}^{2} ]}_{{pk}_{j}} )}^{{c}_{2}^{′}} * {( {[ {C}_{3}^{2} ]}_{{pk}_{j}} )}^{{c}_{3}^{′}} \\ = {[ {( N * {m}_{1} - m )}^{2} + {( N * {m}_{2} - m )}^{2} + {( N * {m}_{1} - m )}^{2} ]}_{{pk}_{j}}\end{matrix}$$

Finally, [M′]ₚₖ_{ⱼ} can be sent to DR j.

Phase 490 (Data Access at DR): DR j can obtain M′ by calling Dec( ) and then get the variance:

M′=(N*m₁−m)²+(N*m₂−m)²+(N*m₁−m)²;

M=M′/N³.

In the following, processing involving multiple CPs 130 will be described. Due to length limitations, we will only present such basic operations as addition, subtraction, multiplication, and comparison across the CPs 130 in this section. We set an example of two encrypted data belonging to two CPs: CP B and CP V. Besides the settings above, we further set the key pair of B and V as (SK_{b}, PK_{b})=(b, g^{b} mod n²) and (SKᵥ, PKᵥ)=(v, h^{v}). Hence, we have PK=PK_{b}^{a}=PKₐ^{b} and PK′=PKᵥ^{a}=PKₐ^{v}. Two messages are encrypted as:

[m₁]_{PK}={T₁=(1+m₁*n)PK^{r}^{₁} mod n², T₁′=g^{r}^{₁} mod n²}.

[m₂]_{PK′}={T₂=(1+m₁*n)PK′^{r}^{₂} mod n², T₂′=g^{r}^{₂} mod n²}.

That is to say, the data provider of m₁ trusts CP B; while the data provider of m₂ trusts CP V. Hence, they encrypt their data with the corresponding Diffie-Hellman key (PK or PK′).

DR j with key pair (skⱼ, pkⱼ)=(kⱼ, g^{k}^{ⱼ} mod n²) wants to obtain a data processing result across CPs. We assume DR j is a customer of CP B. The detailed procedure is introduced as follows.

Addition across CPs 130: This computation wants to obtain the sum of data over two servers.

Data Preparation at DSP: DSP selects a random number w and then operates as follows: 1) Encrypt w and −w: [w]_{PK} and [−w]_{PK′}; and 2) Compute [m₁+w]_{PK} and [m₂−w]_{PK′}; then 3) call PDec1( ) to re-encrypt the two data to obtain [m₁+w]_{PK}_{_{B}} and [m₂−w]_{PK}_{_{V}}.

Data Process at CPs: Upon receiving [m₁+w]_{PK}_{_{B}} CP B first checks its CID and determines if the requester is allowed to access the data; if positive, CP B calls PDec2( ) to obtain the fused raw data m₁+w and then encrypt it with DR j's public key [m₁+w]ₚₖ_{ⱼ}. Similar to the operations of CP B, CP V also obtains [m₂−w]ₚₖ_{ⱼ}.

Additional Operation at DSP: DSP 120 multiplies the two ciphertexts to obtain [m₁+m₂]ₚₖ_{ⱼ} and then forwards it to DR. Finally DR j can directly get the sum of data (m₁+m₂) by calling Dec( ).

Subtraction across CPs 130: the operation is similar to addition, but it needs to do one more operation to obtain the negative of subtractor by doing exponentiation with the power of (n−1).

Multiplication across CPs 130: Different from Multiplication described earlier with reference to a single CP 130, multiple CPs are involved in the computation and leads to a slightly higher computation on the CPs.

Data Preparation at DSP: The DSP selects two random numbers (c₁, c₂) to conceal the raw data, and set c₃=(c₂*c2)⁻¹ mod n. Then the DSP does the same operations about Multiplication as those described above and obtains:

[c₁*m₁]_{PK}_{_{B}}=( [symbol] , [symbol] )={T₁^{c}^{₁}, (T₁′)^{a*c}^{₁}}={(1+c₁*m₁*n)*PK^{r}^{₁}^{*c}^{₁}, g^{r}^{₁}^{*a*c}^{₁}}

[c₂m₂]_{PK}_{_{V}}=( [symbol] , [symbol] )={T₂^{c}^{₂}, (T₂′)^{a*c}^{₂}}={(1+c₂*m₂*n)*PK′^{(r}^{₂}^{*c}^{₂}⁾, g^{r}^{₂}^{*a*c}^{₂}}

[c₃]ₚₖ_{ⱼ}=(Tⱼ, Tⱼ′)={(1+c₃*n)*pkⱼ^{r}^{₃}, g^{r}^{₃}}

The data packet sent to CP B is {[c₁*m₁]_{PK}_{_{B}}, [c₃]ₚₖ_{ⱼ}}; while the data [c₂*m₂]_{PK}_{_{V}} is sent to CP V.

Data Process at CPs: Upon receiving the data package, the CP first checks the legality and its access policy, and then calls PDec2( ) if it is positive. Concretely, the CP V obtains the value of c₂*m₂, encrypts it with PK_{B} and then sends [c₂*m₂]_{PK}_{_{B}} to the CP B. The CP B obtains the two plaintext and multiplies them to get c₁*c₂*m₁*m₂.

Finally, the CP B encrypts c₁*c₂*m₁*m₂ with the DR j's public key and sends it together with [c₃]ₚₖ_{ⱼ} to DR j.

Data Access at DR: Upon obtaining the data form the CP B, the DR can directly calls Dec( ) to get the data of c₁*c₂*m₁*m₂ and c₃. Finally, it can get:

m=m₁*m₂=c₁*c₂*m₁*m₂*c₃ mod n.

Comparison across CPs 130: Different from the Comparison over one CP, the initial operation is executed by the CPs 130 rather than the DSP 120.

First, the DSP directly sends the data [m₁]_{PK} and [m₂]_{PK}, to the CP B and the CP V respectively.

Data Preparation at CPs: The CP V calls PDec1( ) to obtain [m₂]_{PK}_{ₐ} and then sends it to the CP B through a secure way. The CP B first decrypts to obtain [m₁]_{PK}_{ₐ} and computes as follows:

[m₁₋₂]_{PK}_{ₐ}=[m₁]_{PK}_{ₐ}*([m₂]_{PK}_{ₐ})ⁿ⁻¹;

{T, T′}=[2*m₁₋₂+1]_{PK}_{ₐ}={[m₁₋₂]_{PK}_{ₐ}}²*[1]_{PK}_{ₐ};

Then it flips a coins. If s=0; it computes as follows:

( [symbol] , [symbol] )={T^{n-c}^{₁}, (T′)^{a*(n-c}^{₁}⁾}

Otherwise, it computes ( [symbol] , [symbol] )={T^{c}^{₁}, T′^{a*c}^{₁}}

The CP B also encrypts s with the public key of DR: [s]ₚₖ_{ⱼ}=(Tₛ, Tₛ′), and then sends ( [symbol] , [symbol] ) and [s]ₚₖ_{ⱼ} to the DSP.

Data Process at DSP: The DSP decrypts ( [symbol] , [symbol] ) to obtain raw data m′=(−1)^{s+1}*c₁*[2*(m₁−m₂)+1] mod n². The DSP compares its length with [symbol] (n)/2. If [symbol] (m′)< [symbol] (n)/2, it encrypts u=1 with pkⱼ; otherwise, it encrypts u=0 with pkⱼ;

[u]ₚₖ_{ⱼ}=(Tᵤ, Tᵤ′)={(1+u*n)*pkⱼ^{r}^{ᵤ}, g^{r}^{ᵤ}}

It further multiplies the two ciphertexts.

[s+u]ₚₖ_{ⱼ}=(T̅, T̅′)={Tₛ*Tᵤ, Tₛ′*Tᵤ′}

Data Access at DR: DR j can call Dec( ) to obtain the final result: u+s=T̅/T̅′)^{k}^{ⱼ}. Then DR j determines the sign of m₁₋₂. If u+s=1, the original data is negative (i.e., m₁<m₂); otherwise, it is positive or zero (i.e., m₁≥m₂). Comparing with the schemes described herein above, we can observe that the cross-CP computation does not introduce too much overhead. For example, in Addition, the DSP needs to do some encryptions on random numbers, but it calls PDec1( ) rather than SPRE( ), which is more efficient. The CP also only needs to do one more PDec2( ) and one more Enc( ). The computation cost of DR is low due to the high efficiency of Dec( ).

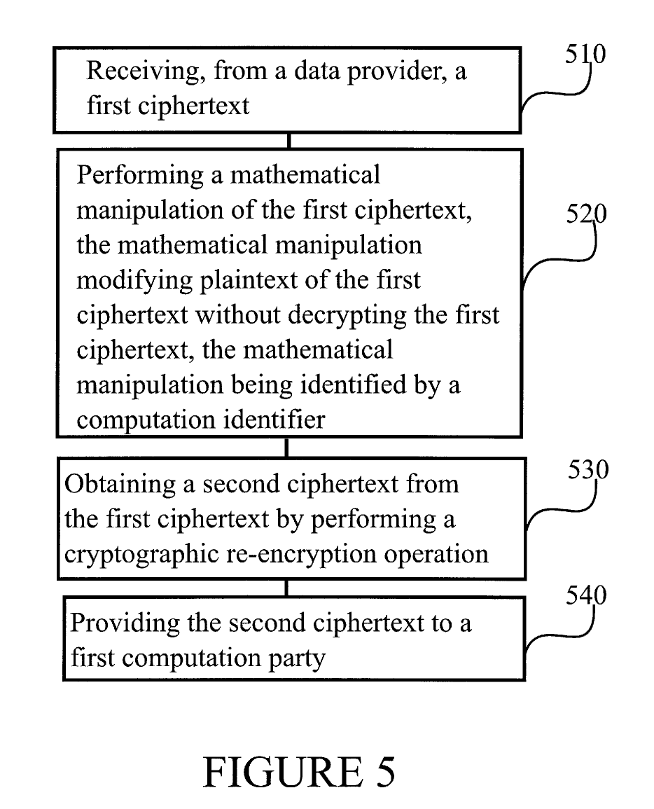

FIG. 5 is a flow graph of a method in accordance with at least some embodiments of the present invention. The phases of the illustrated method may be performed in DSP 120, or in a control device configured to control the functioning thereof, when implanted therein.

Phase 510 comprises receiving, from a data provider, a first ciphertext. Phase 520 comprises performing a mathematical manipulation of the first ciphertext, the mathematical manipulation modifying plaintext of the first ciphertext without decrypting the first ciphertext, the mathematical manipulation being identified by a computation identifier. Phase 530 comprises obtaining a second ciphertext from the first ciphertext by performing a cryptographic re-encryption operation. Finally, phase 540 comprises providing the second ciphertext to a first computation party

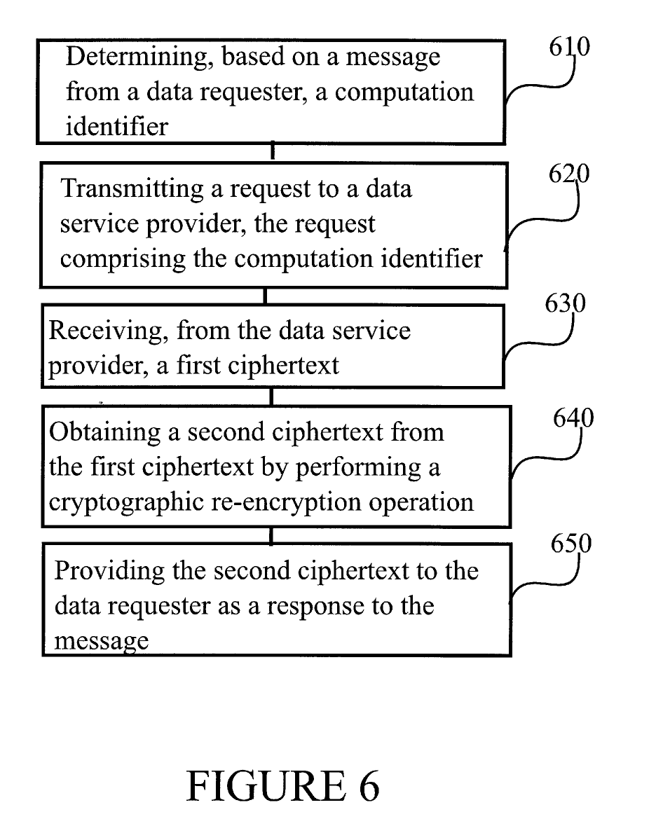

FIG. 6 is a flow graph of a method in accordance with at least some embodiments of the present invention. The phases of the illustrated method may be performed in CP 130, or in a control device configured to control the functioning thereof, when implanted therein.

Phase 610 comprises determining, based on a message from a data requester, a computation identifier. Phase 620 comprises transmitting a request to a data service provider, the request comprising the computation identifier. Phase 630 comprises receiving, from the data service provider, a first ciphertext. Phase 640 comprises obtaining a second ciphertext from the first ciphertext by performing a cryptographic re-encryption operation. Finally, phase 650 comprises providing the second ciphertext to the data requester as a response to the message.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in secure data processing.

### ACRONYMS LIST

ABC Definition
CID computation identifier
CP computation party
EDD Emmanuel, Dario and David mechanism
DP data provider
DSP data service provider
HRES homomorphic re-encryption scheme
PRE proxy re-encryption
DR data requester

REFERENCE SIGNS LIST

| | |
|---|---|
| 110 | data provider |
| 120 | data service provider |
| 130 | computation party |
| 140 | data requester |
| 300-370 | structure of the device of FIG. 3 |
| 410-490 | phases of the method of FIG. 4 |
| 510-540 | phases of the method of FIG. 5 |
| 610-650 | phases of the method of FIG. 6 |

1. An apparatus, comprising:
at least one processor; and
at least one memory including computer program code, the at least one memory and the computer program code being configured to, with the at least one processor, cause the apparatus at least to perform:
receiving, from a data provider, a first ciphertext;
performing a mathematical manipulation of the first ciphertext, the mathematical manipulation modifying plaintext of the first ciphertext without decrypting the first ciphertext, the mathematical manipulation being identified by a computation identifier;
obtaining a second ciphertext from the first ciphertext by performing a cryptographic re-encryption operation; and
providing the second ciphertext to a first computation party.

2. The apparatus according to claim 1, wherein the apparatus is configured to obtain the computation identifier from the first computation party.

3. The apparatus according to claim 1, wherein the apparatus is further configured to participate in negotiating a shared secret with the first computation party.

4. The apparatus according to claim 3, wherein the cryptographic re-encryption operation is performed in dependence of the computation identifier.

5. The apparatus according to claim 1, wherein the second ciphertext is not decryptable solely by a secret key of the first computation party.

6. The apparatus according to claim 1, wherein the apparatus is further configured to obtain a key pair comprising a public key of the apparatus and a secret key of the apparatus.

7. The apparatus according to claim 1, wherein the computation identifier identifies at least one of the following processes: addition, subtraction, multiplication, sign acquisition, comparison, equivalence test and variance.

8. The apparatus according to claim 1, wherein the apparatus is further configured to obtain a third ciphertext from the first ciphertext, to provide the third ciphertext to a second computation party, and to obtain a fourth ciphertext from responses received in the apparatus from the first computation party and the second computation party, and to obtain an encrypted result of a computation process identified by the computation identifier.

9. An apparatus, comprising:
at least one processor,
at least one memory including computer program code, the at least one memory and the computer program code being configured to, with the at least one processor, cause the apparatus at least to perform:
determining, based on a message from a data requester, a computation identifier;
transmitting a request to a data service provider, the request comprising the computation identifier;
receiving, from the data service provider, a first ciphertext;
obtaining a second ciphertext from the first ciphertext by performing a cryptographic re-encryption operation; and
providing the second ciphertext to the data requester as a response to the message.

10. The apparatus according to claim 9, wherein the apparatus is further configured to check an access policy before providing the request to the data service provider.

11. The apparatus according to claim 9, wherein the apparatus is further configured to participate in negotiating a shared secret with the data service provider.

12. The apparatus according to claim 11, wherein the negotiating comprises a Diffie-Hellman negotiation.

13. The apparatus according to claim 9, wherein the apparatus is configured to perform the cryptographic re-encryption operation in dependence of the computation identifier.

14. The apparatus according to claim 9, wherein the computation identifier identifies one of the following computation processes: addition, subtraction, multiplication, sign acquisition, comparison, equivalence test and variance.

15-28. (canceled)

29. A system comprising an apparatus according to claim 1, an apparatus according to claim 9, a data requester and a data provider.

30. (canceled)

31. (canceled)

32. A computer program embodied on a non-transitory computer readable medium having stored thereon a set of computer readable instructions that, when executed by at least one processor, cause an apparatus to at least:
receive, from a data provider, a first ciphertext;
perform a mathematical manipulation of the first ciphertext, the mathematical manipulation modifying plaintext of the first ciphertext without decrypting the first ciphertext, the mathematical manipulation being identified by a computation identifier;
obtain a second ciphertext from the first ciphertext by performing a cryptographic re-encryption operation; and
provide the second ciphertext to a first computation party.

33. A computer program embodied on a non-transitory computer readable medium having stored thereon a set of computer readable instructions that, when executed by at least one processor, cause an apparatus to at least:
obtain a key pair comprising a public key of an apparatus and a secret key of the apparatus;
determine, based on a message from a data requester, a computation identifier;
transmit a request to a data service provider, the request comprising the computation identifier and a public key of the data requester;
receive, from the data service provider, a first ciphertext;
obtain a second ciphertext from the first ciphertext by performing a cryptographic re-encryption operation; and
provide the second ciphertext to the data requester as a response to the message.

34. (canceled)
